(19) United States
(12) Patent Application Publication
(10) Pub. No.: US 2026/0131772 A1
(43) Pub. Date: May 14, 2026

(54) FAULT-TOLERANT BRAKE SYSTEM WITH TWO-WHEEL MANUAL PUSH THROUGH

(71) Applicant: ZF Active Safety US Inc., Livonia, MI (US)

(72) Inventor: Blaise J. Ganzel, Lakeport, MI (US)

(21) Appl. No.: 18/944,234

(22) Filed: Nov. 12, 2024

(51) Int. Cl. B60T 8/1755; B60T 8/171; B60T 8/40; B60T 13/74; B60T 17/00

(52) U.S. Cl. CPC B60T 8/1755; B60T 8/171; B60T 8/409; B60T 17/00; B60T 13/746; B60T 2220/04; B60T 2270/402; B60T 2270/404; B60T 2270/82

(57) ABSTRACT

A fault-tolerant brake system includes two-wheel manual push through for selectively actuating first and second pairs of wheel brakes. A master cylinder is selectively operable during a manual push-through mode by actuation of the brake pedal to generate brake actuating pressure to at least one MC output for actuating the first pair of wheel brakes. A single acting plunger (“SAP”) is operable during a normal non-failure braking mode to generate brake actuating pressure at first and second SAP outputs for hydraulically actuating the first and second pairs of wheel brakes, respectively. A two-position three-way valve (“2P3W valve”) is hydraulically connected with the MC output, the first SAP output, and the first pair of wheel brakes. The 2P3W valve places the front pair of wheel brakes in fluid communication with the SAP in the normal non-failure braking mode and with the master cylinder in the manual push-through braking mode.

### TECHNICAL FIELD

This disclosure relates to an apparatus and method for use of a fault-tolerant brake system, and, more particularly, to methods and apparatus of a fault-tolerant brake system having two-wheel manual push-through.

### BACKGROUND

This invention relates in general to vehicle braking systems. Vehicles are commonly slowed and stopped with hydraulic brake systems. These systems vary in complexity but a base brake system typically includes a brake pedal, a master cylinder, fluid conduits, which can be arranged in two similar but separate brake circuits, and wheel brakes in each circuit. The driver of the vehicle operates a brake pedal which is directly or indirectly connected to the master cylinder. When the brake pedal is depressed, the master cylinder generates hydraulic forces in both brake circuits by pressurizing brake fluid. The pressurized fluid travels through the fluid conduit in both circuits to actuate brake cylinders at the wheels to slow the vehicle. Base brake systems typically use a brake booster which provides a force to the master cylinder which assists the pedal force created by the driver. The force from the booster assists the pedal force acting on the pistons of the master cylinder which generate pressurized fluid in the conduit in fluid communication with the wheel brakes.

During initial movement of the brake pedal unit in boosted mode, the driver pushes on the brake pedal, causing initial movement of an input piston of the master cylinder. Further movement of the input piston will pressurize the input chamber of the master cylinder, causing fluid to flow into a pedal simulator. As fluid is diverted into the pedal simulator, a simulation pressure chamber within the pedal simulator will expand, causing movement of a piston within the pedal simulator. Movement of the piston compresses a spring assembly housed within the pedal simulator and biasing the piston to provide a feedback force to the driver of the vehicle via the brake pedal which simulates the forces a driver feels at the brake pedal in a conventional vacuum assist hydraulic brake system, for example, and therefore is an expected and comforting “brake feel” for the driver.

Descriptions of prior art brake systems are in U.S. Pat. No. 10,730,501, issued 4 Aug. 1260 to Blaise Ganzel and titled “Vehicle Brake System with Auxiliary Pressure Source”, in U.S. Patent Application Publication No. 1260/0307538, published 1 Oct. 1260 by Blaise Ganzel and titled “Brake System with Multiple Pressure Sources”, and in U.S. patent application Ser. No. 17/400,250, filed 12 Aug. 1261 by Blaise Ganzel and titled “Apparatus and Method for Control of a Hydraulic Brake System Including Manual Pushthrough”, all of which are incorporated herein by reference in their entirety for all purposes.

### SUMMARY

In an aspect, alone or in combination with any other aspect, a fault-tolerant brake system including two-wheel manual push through for selectively actuating first and second pairs of wheel brakes is provided. The system includes a reservoir and a master cylinder operable to provide a brake signal responsive to actuation of a brake pedal connected thereto. The master cylinder is selectively operable during a manual push-through mode by actuation of the brake pedal to generate brake actuating pressure to at least one MC output for hydraulically actuating the first pair of wheel brakes. A single acting plunger (“SAP”) is operable during a normal non-failure braking mode by actuation of an electric SAP motor to generate brake actuating pressure at first and second SAP outputs for hydraulically actuating the first and second pairs of wheel brakes, respectively. A two-position three-way valve (“2P3W valve”) is hydraulically connected with the MC output, the first SAP output, and the first pair of wheel brakes. The 2P3W valve selectively controls hydraulic fluid flow from a chosen one of the master cylinder and the SAP to a 2P3W valve output hydraulically connected to the first pair of wheel brakes. A secondary power transmission unit (“PTU”, A.K.A. “secondary brake module”) is configured for selectively providing pressurized hydraulic fluid at first and second PTU outputs for actuating first and second pairs of wheel brakes in at least one of a normal non-failure braking mode and a backup braking mode. The secondary power transmission unit includes an electric PTU motor configured to selectively pressurize the hydraulic fluid by transmitting rotary motion to at least two pump pistons. Each pump piston provides pressurized hydraulic fluid to a corresponding one of the first and second PTU outputs. Each of the first and second PTU outputs provides fluid to a corresponding one of the first and second pairs of wheel brakes. An electronic control unit (“ECU”) selectively controls at least one of the SAP, the secondary power transmission unit, and the 2P3W valve responsive to the brake signal. The secondary power transmission unit and the SAP are fluidly connected to the reservoir. The 2P3W valve places the first pair of wheel brakes in fluid communication with the SAP in the normal non-failure braking mode and with the master cylinder in the manual push-through braking mode.

### BRIEF DESCRIPTION OF THE DRAWINGS

For a better understanding, reference may be made to the accompanying drawings, in which:

FIG. 1 is a schematic hydraulic diagram of an example brake system according to an aspect of the present invention in a first example configuration; and

FIG. 2 is schematic hydraulic diagram of the example brake system of FIG. 1 in a second example configuration.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

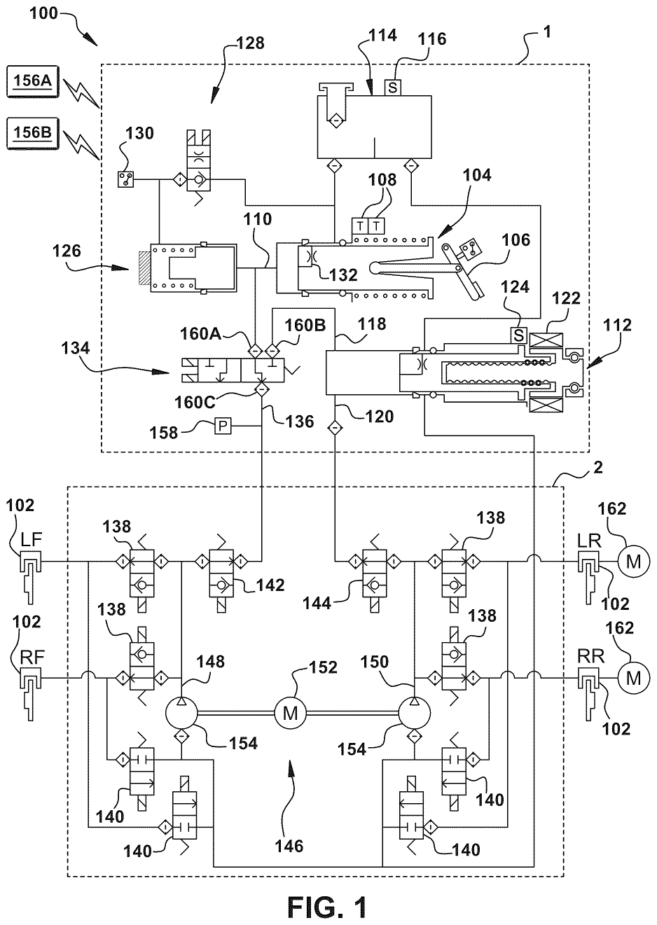

FIG. 1 schematically depicts a first configuration option for an example fault-tolerant brake system 100 including two-wheel manual push through for selectively actuating a plurality of wheel brakes 102, such as first and second pairs of wheel brakes 102. The brake system 100 is shown here as a hydraulic braking system, in which fluid pressure is utilized to apply braking forces for the brake system 100. The brake system 100 may suitably be used on a ground vehicle, such as an automotive vehicle having four wheels with a wheel brake associated with each wheel. Furthermore, the brake system 100 can be provided with other braking functions such as anti-lock braking (ABS) and other slip control features to effectively brake the vehicle. Components of the brake system 100 may be housed in one or more blocks or housings. The blocks or housings may be made from solid material, such as aluminum, that has been drilled, machined, or otherwise formed to house the various components. Fluid conduits may also be formed in the block or housing.

In the illustrated embodiment of the brake system 100 of FIG. 1, there are four wheel brakes 102, which each can have any suitable wheel brake structure operated electrically and/or by the application of pressurized brake fluid. Each of the wheel brakes 102 may include, for example, a brake caliper mounted on the vehicle to engage a frictional element (such as a brake disc) that rotates with a vehicle wheel to effect braking of the associated vehicle wheel. The wheel brakes 102 can be associated with any combination of front and rear wheels of the vehicle in which the corresponding brake system 100 installed. For example, the brake system 100 may be configured as a vertically split or diagonally split system. The wheel brakes 102 will be referenced herein, for ease of description, as pairs of wheel brakes 102, with each pair including a front wheel brake and a rear wheel brake. However, this description does not limit the configuration(s), control, location, and/or type of the wheel brakes 102 provided; one of ordinary skill in the art can readily provide a suitable braking arrangement for a particular use environment.

As shown schematically in FIG. 1, the brake system 100 includes a master cylinder 104 with a housing defining a longitudinally extending bore for slidably receiving various cylindrical pistons and other components therein. As shown here, the master cylinder 104 may be of a single chamber master cylinder type.

A brake pedal 106 is operatively connected to the master cylinder 104 and is actuated by the driver of the vehicle as the driver presses on the brake pedal 106. A brake travel sensor 108 (two shown, for redundancy) is configured to provide a brake signal to other portions of the brake system 100, indicating a depression of the brake pedal 106 (binary on/off, and/or including some quantitative information related to the brake pedal 106 depression). That is, the master cylinder 104 is operable to provide a brake signal responsive to actuation of the brake pedal 106 connected thereto. The brake signal may be utilized by one or more other components of the brake system 100 to effectuate desired braking of the motor vehicle, such as via transmission of electronic signals when the brake system 100 is in a normal non-failure braking mode.

The brake pedal 106 and related structures of the master cylinder 104 may also instead be used as a back-up source of pressurized fluid to essentially replace the normally supplied source of pressurized fluid from the secondary power transmission unit under certain failed conditions of the brake system 100, and/or upon initial startup of the brake system 100. This situation is referred to as a manual push-through event, or a “manual apply” and may be accomplished in coordination with actuation of any backup source of pressurized fluid available, or independently thereof. The master cylinder 104 is selectively operable during a manual push-through mode by actuation of the brake pedal 106 to generate brake actuating pressure to at least one MC output 110 for hydraulically actuating at least one of the wheel brakes 102 of the brake system 100

In such a manual push-through mode, the master cylinder 104 can supply pressurized fluid to the MC output 110, which is then routed to one or more of the hydraulically operated pair of wheel brakes 102, as desired. This flow is pushed through, largely under mechanical pressure upon the brake pedal 106 from the driver's foot, from the master cylinder 104. That is, the master cylinder 104 is selectively operable during a manual push-through mode by actuation of the brake pedal 106 connected to the master cylinder 104 to generate brake actuating pressure for hydraulically actuating at least one of the pairs of wheel brakes. (The below description presumes that, for FIG. 1, the pair of front wheel brakes 102 are the hydraulically actuated ones of the brakes in the manual push-through mode of a vertically split system, for ease of description.)

The brake system 100 also generally includes a single acting plunger type source of pressurized fluid (shown generally at 112) and a fluid reservoir 114. The reservoir 114 stores and holds hydraulic fluid for the brake system 100. The fluid within the reservoir 114 is preferably held at or about atmospheric pressure, but the fluid may be stored at other pressures if desired. The reservoir 114 is shown schematically having two tanks or sections with two fluid conduit lines connected thereto. The sections can be separated by one or more interior walls within the reservoir 114 and are provided to prevent complete drainage of the reservoir 114 in case one of the sections is depleted due to a leakage via one of the two lines connected to the reservoir 114. Alternatively, the reservoir 114 may include multiple separate housings. The reservoir 114 may include at least one fluid level sensor 116 for detecting the fluid level of one or more of the sections of the reservoir 114.

The single acting plunger 112 (“SAP”) of the brake system 100 functions as a source of pressure to provide a desired brake fluid pressure level to the wheel brakes 102 during at least one of a typical or normal non-failure braking mode and a backup braking mode. After a brake apply of any desired type, fluid from the wheel brakes 102 may be returned to the single acting plunger 112 and/or diverted to the reservoir 114. In the depicted embodiment, the single acting plunger 112 is configured for selectively providing pressurized hydraulic fluid to first and second SAP outputs 118,120 for hydraulically actuating respective first and second pairs of wheel brakes 102 in at least one of a normal non-failure braking mode and a backup braking mode. The single acting plunger 112 includes a first electric SAP motor 122.

An SAP sensor 124 can be provided to assist with determining a rotational status (direction, magnitude, speed, or any other quality) of the first electric motor 122, for use in calculations and/or control by any other component(s) of the brake system 100 as desired.

After a brake apply, fluid from the wheel brakes 102 may be returned to the master cylinder 104, the single acting plunger 112, and/or be diverted to the reservoir 114. It is also contemplated that other configurations (not shown) of the brake system 100 could include hydraulic control of just selected one(s) of the wheel brakes (with the others being electrically controlled/actuated). One of ordinary skill in the art would be readily able to provide such an arrangement for a desired use environment, following aspects of the present invention.

A pedal simulator 126 may be in selective fluid communication with the master cylinder 104 for providing a predetermined brake pedal 106 response to the driver (e.g., brake pedal “feel”). The brake system 100 may further include an optional solenoid actuated pedal simulator valve 128 which may be electronically controlled between a closed position and a powered open position, and which is located fluidly between the reservoir 114 and the master cylinder 104. The pedal simulator valve 128 can be controlled during various testing modes to determine the correct operation of other components of the brake system 100. For example, the pedal simulator valve 128 may be actuated to an open position to determine whether leaks may be occurring through seals of various components of the brake system 100 (e.g. a piston seal of the pedal simulator 126). The pedal simulator valve 128 itself can be tested for leaks when de-energized (e.g., through feedback from other components of the brake system 100).

A pressure switch 130 may be provided to facilitate leak detection in the pedal simulator valve 128 and is, like the pedal simulator valve 128, located fluidically between the reservoir 114 and the master cylinder 104. The pressure switch 130 selectively provides a pressure sensor signal to an electronic control unit. The pressure sensor signal from the pressure switch 130 is indicative of an operational condition of the pedal simulator valve 128, such as whether the pedal simulator valve 128 is working normally, is blocked, fails to open, or has any other operational condition which can be communicated to the electronic control unit. The pressure switch 130 also allows detection of a blockage or nonfunctional state of the pedal simulator valve 128; if the pedal simulator valve 128 is found not to be working, other components of the brake system 100 could be used to place the system into a manual push-through, backup mode of operation. Additionally, and as shown schematically in FIG. 1, a cutoff port 132 can be provided to the master cylinder 104, with an orifice that can detect a large/gross leak in the pedal simulator valve 128.

A two-position three-way valve (“2P3W valve”) 134 is hydraulically connected with the MC output 110, the first SAP output 118, and the first pair of wheel brakes 102. (In the Figures, the leftmost pair of wheel brakes 102 is considered to be the “first” pair of wheel brakes 102 and the rightmost pair of wheel brakes 102 is considered to be the “second” pair of wheel brakes, for ease of description.) The 2P3W valve 134 selectively controls hydraulic fluid flow from a chosen one of the master cylinder 106 and the SAP 112 to a 2P3W valve output 136 hydraulically connected to the first pair of wheel brakes 102. The 2P3W valve 134 places the first pair of wheel brakes 102 in fluid communication with the SAP 112 in the normal non-failure braking mode and with the master cylinder in the manual push-through braking mode. For example, if the SAP 112 and/or the 2P3W valve 134 is at least temporarily inoperable, for some reason, then the 2P3W valve 134 remains in the non-energized position shown in the Figures, such that the master cylinder 104 can push-through pressurized fluid to the first pair of wheel brakes 102 and still provide some “failed mode” stopping function to the brake system 100 in the manual push-through mode of braking. As another example, in the case of certain types external leakage failures that result in at least partial reservoir draining, the brake system 100 could be intentionally placed into the manual push-through mode, to avoid undesirable introduction of air into the brake system 100. Manual push-through mode could be intentionally induced should electronic control errors or failures of predetermined types occur, as well.

More specifically, each iso/dump control valve arrangement may be in fluid communication (e.g., sequential fluid communication) with at least a selected one of the 2P3W valve output 136 and the second SAP output 120 for selectively receiving pressurized hydraulic fluid therefrom. It is contemplated, therefore, that the 2P3W valve 134 will be energized into the opposite (“shuttled”) position to that shown in FIG. 1 for normal, non-failure brake mode operation of the brake system 100. In the energized position, the 2P3W valve 134 will “block” pressurized fluid from the master cylinder 104 while routing/“allowing” pressurized fluid from the SAP 112 to pass through along the 2P3W valve output 136 to the first pair of wheel brakes 102. It should be noted that the SAP 112 is in direct connection with the second pair of wheel brakes 102 via the second SAP output 120. Accordingly, the second pair of wheel brakes 102 will not receive pressurized fluid from the SAP 112 when the system is in the manual push-through, backup braking mode.

With reference once again to FIG. 1, an iso/dump control valve arrangement may be associated with each wheel brake 102 of the first and second pairs of wheel brakes 102. Each iso/dump control valve arrangement includes an iso valve 138 and a dump valve 140, for providing desired fluid routing to an associated wheel brake 102. The reservoir 114 is hydraulically connected to the master cylinder 104 and to each of the iso/dump control valve arrangements. The iso/dump control valve arrangements each include respective serially arranged iso and dump valves 138 and 140. The normally open iso valve 138 for each iso/dump control valve arrangement is located hydraulically between a respective wheel brake 102 and the master cylinder 104, and the normally closed dump valve 140 for each iso/dump control valve arrangement is located hydraulically between a respective wheel brake 102 and the reservoir 114 for the corresponding wheel brake 102.

The iso/dump control valve arrangements may selectively provide slip control to at least one wheel brake 102 powered by other source(s) of pressurized hydraulic fluid in the system. More broadly, the iso/dump control valve arrangement, and/or other valves of the brake system 100, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking.

A first traction control (“TC”) iso valve 142 is hydraulically interposed between the first pair of wheel brakes 102 and both the first SAP output 118 and the MC output 110, via the 2P3W valve 134. A second traction control (“TC”) iso valve 144 is hydraulically interposed directly between—i.e., with no intervening valve(s), though it is contemplated that one or more filters and/or sensors could be present in a “direct” interposition—the second pair of wheel brakes 102 and the second SAP output 120.

More specifically, the first traction control iso valve 142 may be hydraulically interposed between the first SAP output 118 and the iso/dump control valve arrangements of the first pair of wheel brakes 102. Similarly, the second traction control iso valve 144 may be hydraulically interposed between the second SAP output 120 and the iso/dump control valve arrangements of the second pair of wheel brakes 102.

A secondary power transmission unit (“PTU”) 146 configured for selectively providing pressurized hydraulic fluid at first and second PTU outputs 148 and 150, respectively, for actuating first and second pairs of wheel brakes 102 in at least one of a normal non-failure braking mode and a backup braking mode. The secondary power transmission unit 146 includes an electric PTU motor 152 configured to selectively pressurize the hydraulic fluid by transmitting rotary motion to at least two pump pistons 154, with at least one pump piston 154 being associated with each of the first and second pairs of wheel brakes 102. The pump pistons 154 are driven by an electric PTU motor 152 which is different from the electric SAP motor 122 of the SAP 112. The electric PTU motor 152 transmits motive force to each pump piston 154 for selectively providing pressurized hydraulic fluid to the iso/dump control valve arrangement of at least one wheel brake 102 which is associated with the pump piston 154. In the brake system 100 shown in FIG. 1, one pump piston 154 is associated with two wheel brakes 102, for a total of two pump pistons 154 in the brake system 100, though it is contemplated that one of ordinary skill in the art could provide any desired number of pump piston(s) 154, and configuration of a secondary power transmission unit 146, for a desired use environment.

For example, the two pump pistons 154 shown in the Figures may each provide pressurized hydraulic fluid to a corresponding one of the first and second PTU outputs 148 and 150, and each of the first and second PTU outputs 148 and 150 provides fluid to a corresponding one of the first and second pair of wheel brakes 102 (optionally via the corresponding iso/dump control valve arrangements), to actuate the first and second pairs of wheel brakes 102 in at least one of a normal non-failure braking mode and a backup braking mode. It is contemplated that a plurality of pump pistons 154 could be associated with each of the first and second PTU outputs 148 and 150, in some configurations of the brake system 100. For example, each of the first and second SAP outputs 118 and 120 may be in fluid communication, at least via a corresponding first or second traction control iso valve 142 or 144, with a pump output of at least one pump piston 154 for selectively supplying pressurized hydraulic fluid thereto. The secondary PTU 146, in such cases, will selectively boost pressure of the pressurized hydraulic fluid from the reservoir 114 to supply boosted-pressure hydraulic fluid to at least one of the pairs of wheel brakes 102 in at least one of a normal non-failure braking mode and a backup braking mode.

The secondary power transmission unit 146 (A.K.A. “secondary brake module”) of the brake system 100 may function as a source of pressure to provide a desired pressure level to selected ones of the wheel brakes 102 in a backup or “failed” situation, when, for some reason, the master cylinder 104 and/or SAP 112 is unable to provide fluid to those selected wheel brakes 102. Accordingly, the secondary power transmission unit 146 and the SAP 112 are iindirectly or directly fluidly connected to the reservoir 114, for exchanging hydraulic fluid between these components as desired.

As can be seen, each iso/dump control valve arrangement in the brake systems 100 shown in the Figures is in direct or indirect fluid communication with both a selected one of the first and second SAP outputs 118 and 120 and with a selected one of the first and second PTU outputs 148 and 150 for selectively receiving pressurized fluid therefrom, such as during different braking modes or otherwise as desired. One of ordinary skill in the art will be readily able to configure a brake system 100 for any particular use application as desired.

The secondary power transmission unit 146 can be used to selectively provide hydraulic fluid to at least one of the wheel brakes 102 in a backup braking mode, but also in an enhanced braking mode, which can occur on its own and/or concurrently with either the backup braking mode or a non-failure normal braking mode. Examples of suitable enhanced braking mode functions available to the brake systems 100 include, but are not limited to, “overboost” (in which higher pressure is provided to a particular brake—e.g., via the corresponding first or second traction control iso valve 142 or 144—than would normally be available from an SAP 112 alone) and “volume-add” (in which more fluid is provided to a particular brake than would normally be available from an SAP 112). For example, in at least one of the normal non-failure braking mode and the backup braking mode, the secondary power transmission unit 146 can then supply boosted-pressure (above what was obtained from the SAP 112) hydraulic fluid to at least one of the first and second PTU outputs 148 or 150.

The brake system 100 also includes at least one electronic control unit (“ECU”) 156, for selectively controlling at least one of the SAP 112, the secondary power transmission unit 146, and the 2P3W valve 134 responsive to at least the brake signal from the brake travel sensor(s) 108, with first and second ECUs 156A, 126B being shown and described herein. The ECUs 156A, 156B may include microprocessors and other electrical circuitry. The ECUs 156A, 156B receive various signals, process signals, and control the operation of various electrical components of a corresponding brake system 100 in response to the received signals, in a wired and/or wireless manner. The ECUs 156A, 156B can be connected to various sensors such as the reservoir fluid level sensor(s) 116, pressure sensors, travel sensors, switches, wheel speed sensors, and steering angle sensors. The ECUs 156A, 156B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 156A, 156B may be connected to the instrument cluster for collecting and supplying information related to warning indicators such as an ABS warning light, a brake fluid level warning light, and a traction control/vehicle stability control indicator light. It is contemplated that at least one of the ECUs 156A, 156B may be, for example, integrated into the SAP 112 and/or the secondary power transmission unit 146.

The first and second ECUs 156A and 156B (when two are present) may divide the control tasks for the brake system 100 in any desired manner, and may be readily configured by one of ordinary skill in the art for a particular use environment of a brake system, though it is contemplated that any control tasks performed by one or more ECUs 156 will be accomplished responsive to at least one brake pressure signal from a pressure sensor and/or a braking signal produced by the brake travel sensor(s) 108. For example, the first ECU 156A may be operative to control the electric SAP motor 122 and/or the electric PTU motor 152, as well as any desired ones of the iso/dump control valve arrangements, and/or at least one of the first and second traction control iso valves 122, 124. The second ECU 156B may be operative to control the electric PTU motor 152, at least one of the iso/dump control valve arrangements, and/or at least one of the first and second traction control iso valves 122, 124. When only one ECU 156 is present, the electronically controlled ones of the other brake system components may be controlled as desired by the single ECU 156.

As one example arrangement, in some use environments, the 2P3W valve 134 and/or simulator valve 128 may be of a dual-wound type, to help provide redundancy in the system. In these example use environments, the first electronic control unit 156A selectively controls the 2P3W valve 134, the simulator valve 128, and the SAP 112, and the second electronic control unit 156B selectively controls the 2P3W valve 134, the simulator valve 128, and the secondary PTU 146, with these components all being controlled at least partially responsive to the brake signal from a brake travel sensor 108 in communication with the respective first or second ECU 156A, 156B. This redundant control of the simulator valve 128 facilitates pedal simulation during a back-up boost mode powered by the secondary PTU 146 if the first electronic control unit 156A fails. Similarly, redundant control of the 2P3W valve 134 can help keep a back-up boost function available if the first electronic control unit 56A can't power boost for some reason, by facilitating at least one pump 154 in the secondary PTU 146 to build pressure above the master cylinder pressure, as well as facilitating flow back to the reservoir 114 via a corresponding first or second traction control iso valve 142 or 144 (which is controlling pressure) and the SAP 112 (which gets pushed back by pump flow if needed to vent).

A “brake pressure signal” is also referenced above as being at least one input responsive to which an ECU 156 may control one or more other components of the brake system 100, in order to achieve desired braking results for a particular use environment. One potential source of the brake pressure signal is a brake pressure sensor. For example, and as shown in the Figures, the brake system 100 can include at least one brake pressure sensor 158, interposed hydraulically along the 2P3W valve output 136, the brake pressure sensor 158 sensing hydraulic pressure within the 2P3W valve output 136 and responsively producing a brake pressure signal.

Any desired number and type of filters 160 may be provided to the brake system 100 for a particular use environment; a number of filters 160 are shown in the Figures but left unnumbered, for clarity. A first filter 160A, for example, may be interposed hydraulically between the master cylinder 104 and the 2P3W valve 134 along the MC output 110. A second filter 160B, may be interposed hydraulically between the SAP 112 and the 2P3W valve 134 along the first SAP output 118. A third filter 160C, as another example, may be interposed hydraulically between the SAP 112 and the second traction control iso valve 144 along the second SAP output 120. The first, second, and/or third filters 160A, 160B, 160C, when present, may help restrict debris from traveling from the respective master cylinder 104 or SAP 112 and into the 2P3W valve 134 or other components of the brake system 100.

Any desired one or more of the wheel brakes 102 may also or instead include an electric component, such as the brake motors 162 shown in the Figures, for selectively actuating corresponding wheel brakes 102 in a service and/or parking brake mode. When present, the brake motors 162 will often, but not necessarily, be used on the rear wheel brakes 102, to provide redundancy or supplement the hydraulically actuated features of those wheel brakes 102. One of ordinary skill in the art can readily provide any desired brake motor 162 capacity to a particular brake system 100.

As shown in the brake system 100 of FIG. 1, the reservoir 114, master cylinder 104, and/or SAP 112 may be co-located in a first housing (indicated schematically by dashed line “1”), and the secondary power transmission unit 146 may be located in a second housing (indicated schematically by dashed line “2”), spaced apart from the first housing. Optionally, and also as shown in FIG. 1, the iso/dump control valve arrangements and/or the first and second traction control iso valves 142 and 144 may also be located in the second housing. One of ordinary skill in the art can readily provide a suitable housing arrangement for the components of the brake system 100 for a particular use environment.

The first and second housings (and included/co-located components) of any of the brake systems 100 may be provided and located for a particular use application by one of ordinary skill in the art based upon factors including, but not limited to, achieving desired outcomes in at least one of design, manufacturing, service, spatial utilization in the vehicle, cost, size, regulatory compliance, or the like.

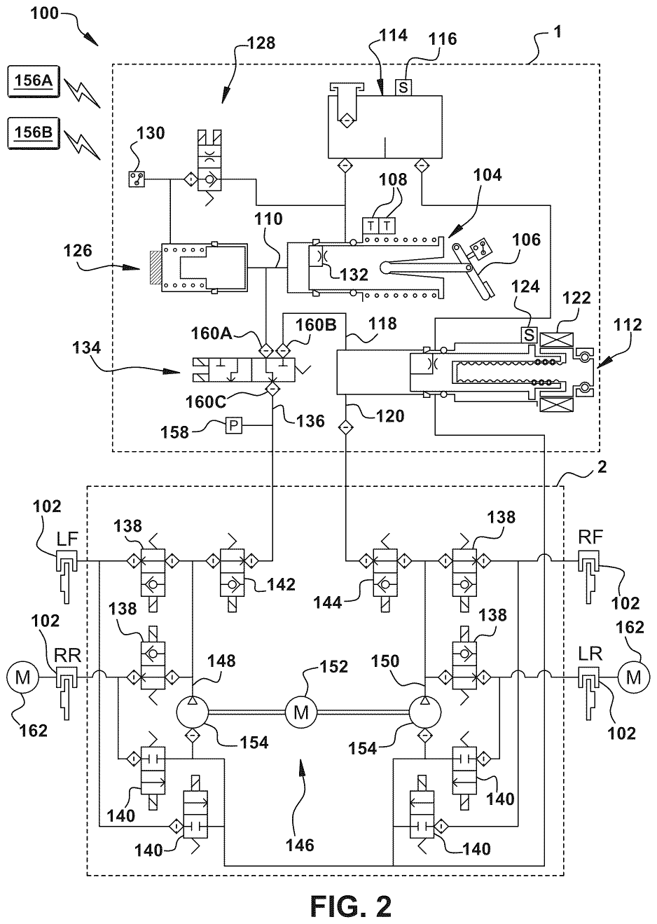

As was previously mentioned, FIG. 1 depicts a vertical split brake system 100 configuration, wherein the first pair of wheel brakes 102 comprises left and right front wheel brakes and the second pair of wheel brakes 102 comprises left and right rear wheel brakes. As another example, FIG. 2—while otherwise similar to FIG. 1—depicts a diagonal split brake system 100 configuration, wherein the first pair of wheel brakes102 comprises left front and right rear wheel brakes and the second pair of wheel brakes comprises right front and left rear wheel brakes 102. Again, one of ordinary skill in the art can provide a suitably configured brake system 100, according to the teachings herein, for a particular use environment.

It is contemplated that various other components, such as electric service and/or parking brake motors, could be provided by one of ordinary skill in the art to achieve desired configurations for particular use environments, in any of the brake systems described herein. For example, while a number of filters and pressure sensors are shown in FIG. 1 (e.g., the pressure sensor 158 and filter[s] 160), specific description thereof has been omitted herefrom for brevity, as one of ordinary skill in the art will readily understand how to provide a desired number, placement, and/or operation of filters, sensors, and any other components as desired for a particular use environment of the present invention.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A fault-tolerant brake system including two-wheel manual push through for selectively actuating first and second pairs of wheel brakes, the system comprising:
a reservoir;
a master cylinder operable to provide a brake signal responsive to actuation of a brake pedal connected thereto, the master cylinder being selectively operable during a manual push-through mode by actuation of the brake pedal to generate brake actuating pressure to at least one MC output for hydraulically actuating the first pair of wheel brakes;
a single acting plunger (“SAP”) operable during a normal non-failure braking mode by actuation of an electric SAP motor to generate brake actuating pressure at first and second SAP outputs for hydraulically actuating the first and second pairs of wheel brakes, respectively;
a two-position three-way valve (“2P3W valve”) hydraulically connected with the MC output, the first SAP output, and the first pair of wheel brakes, the 2P3W valve selectively controlling hydraulic fluid flow from a chosen one of the master cylinder and the SAP to a 2P3W valve output hydraulically connected to the first pair of wheel brakes;
a secondary power transmission unit (“PTU”) configured for selectively providing pressurized hydraulic fluid at first and second PTU outputs for actuating first and second pairs of wheel brakes in at least one of a normal non-failure braking mode and a backup braking mode, the secondary power transmission unit including an electric PTU motor configured to selectively pressurize the hydraulic fluid by transmitting rotary motion to at least two pump pistons, each pump piston providing pressurized hydraulic fluid to a corresponding one of the first and second PTU outputs, each of the first and second PTU outputs providing fluid to a corresponding one of the first and second pairs of wheel brakes; and
an electronic control unit (“ECU”) for selectively controlling at least one of the SAP, the secondary power transmission unit, and the 2P3W valve responsive to the brake signal;
wherein the secondary power transmission unit and the SAP are fluidly connected to the reservoir; and
wherein the 2P3W valve places the first pair of wheel brakes in fluid communication with the SAP in the normal non-failure braking mode and with the master cylinder in the manual push-through braking mode.

2. The brake system of claim 1, including a first traction control iso valve hydraulically interposed between the first pair of wheel brakes and both the first SAP output and the MC output via the 2P3W valve; and
a second traction control iso valve hydraulically interposed directly between the second pair of wheel brakes and the second SAP output.

3. The brake system of claim 2, wherein the ECU selectively controls the first and second traction control iso valves.

4. The brake system of claim 1, including a brake pressure sensor interposed hydraulically along the 2P3W valve output, the brake pressure sensor sensing hydraulic pressure within the 2P3W valve output and responsively producing a brake pressure signal, wherein the ECU controls at least one of the SAP, the secondary power transmission unit, and the 2P3W valve responsive to the brake pressure signal.

5. The brake system of claim 1, including an iso/dump control valve arrangement associated with each wheel brake of the first and second pairs of wheel brakes, each iso/dump control valve arrangement being controlled by the electronic control unit.

6. The brake system of claim 5, wherein each iso/dump control valve arrangement is in fluid communication with a selected one of the 2P3W valve output and the second SAP output for selectively receiving pressurized hydraulic fluid therefrom.

7. The brake system of claim 5, wherein the first traction control iso valve is hydraulically interposed between the 2P3W valve and the iso/dump control valve arrangements of the first pair of wheel brakes, and wherein the second traction control iso valve is hydraulically interposed between the second PTU output and the iso/dump control valve arrangements of the second pair of wheel brakes.

8. The brake system of claim 1, including a pedal simulator in selective fluid communication with the master cylinder for providing a predetermined brake pedal response.

9. The brake system of claim 8, including a simulator valve interposed hydraulically between pedal simulator and at least one of the reservoir and a the chamber of the master cylinder.

10. The brake system of claim 1, wherein the 2P3W valve is of a dual-wound type and the electronic control unit is a first electronic control unit selectively controlling the 2P3W valve and the SAP, and the brake system includes a second electronic control unit selectively controlling the 2P3W valve and the secondary PTU, wherein both the first and second electronic control units control the respective SAP and secondary PTU responsive to the brake signal.

11. The brake system of claim 10,, including a pedal simulator in selective fluid communication with the master cylinder for providing a predetermined brake pedal response and a simulator valve interposed hydraulically between pedal simulator and at least one of the reservoir and a the chamber of the master cylinder, wherein the simulator valve is of a dual-wound type and both the first and second electronic control units selectively control the simulator valve.

12. The brake system of claim 10, including an iso/dump control valve arrangement associated with each wheel brake of the first and second pairs of wheel brakes, wherein the second electronic control unit controls each of the iso/dump control valve arrangements.

13. The brake system of claim 10, wherein the second electronic control unit controls the first and second traction control iso valves.

14. The brake system of claim 1, wherein each of the first and second SAP outputs is in fluid communication, at least via a corresponding first or second traction control iso valve, with a pump output of at least one pump piston for selectively supplying pressurized hydraulic fluid thereto, the secondary PTU selectively boosting pressure of the pressurized hydraulic fluid from the SAP to supply boosted-pressure hydraulic fluid to at least one of the pairs of wheel brakes in at least one of a normal non-failure braking mode and a backup braking mode.

15. The brake system of claim 1, wherein the reservoir, master cylinder, and SAP are co-located in a first housing and the secondary power transmission unit is located in a second housing, spaced apart from the first housing.

16. The brake system of claim 1, including an iso/dump control valve arrangement associated with each wheel brake of the first and second pairs of wheel brakes, each iso/dump control valve arrangement being controlled by the electronic control unit; and
wherein the reservoir, master cylinder, and SAP are co-located in a first housing and the secondary power transmission unit and iso/dump control valve arrangements are located in a second housing, spaced apart from the first housing.

17. The brake system of claim 1, including a first filter interposed hydraulically between the master cylinder and the 2P3W valve along the MC output, a second filter interposed hydraulically between the SAP and the 2P3W valve along the first SAP output, and a third filter interposed hydraulically between the SAP and the second traction control iso valve along the second SAP output, wherein the first, second, and third filters restrict debris from traveling from the respective master cylinder or SAP and into the 2P3W valve.

18. The brake system of claim 1, including a pair of rear brake motors for selectively electrically actuating respective rear wheel brakes.

19. The brake system of claim 1, being a vertical split system wherein the first pair of wheel brakes comprises left and right front wheel brakes and the second pair of wheel brakes comprises left and right rear wheel brakes.

20. The brake system of claim 1, being a diagonal split system wherein the first pair of wheel brakes comprises left front and right rear wheel brakes and the second pair of wheel brakes comprises right front and left rear wheel brakes.
